(19) United States
(12) Patent Application Publication
(10) Pub. No.: US 2016/0253653 A1
(43) Pub. Date: Sep. 1, 2016

(54) PAYMENT CHECKOUT WITHIN AN APPLICATION

(71) Applicant: VISA INTERNATIONAL SERVICE ASSOCIATION, San Francisco, CA (US)

(72) Inventors: Lejo Jacob, San Francisco, CA (US); William Levaggi, San Francisco, CA (US); Peter Berg, San Francisco, CA (US)

(21) Appl. No.: 15/051,845

(22) Filed: Feb. 24, 2016

Related U.S. Application Data
(60) Provisional application No. 62/126,231, filed on Feb. 27, 2015.

(51) Int. Cl. G06Q 20/32

(52) U.S. Cl. CPC G06Q 20/3223; G06Q 20/3276

(57) ABSTRACT

Disclosed is a system for improving a mobile payment application. In an example, the system may provide for receiving from a portable computing device a first payment authorization request message comprising a total amount due and a payment credential, and responding to the portable computing device with a first call identifier. The system may further provide for receiving a second payment authorization request comprising a second call identifier from a merchant backend server, comparing the first call identifier and the second call identifier for verification, and, in response to a successful comparison, communicating a message indicating that the first call identifier has been verified.

### CROSS REFERENCE TO RELATED APPLICATIONS

This application claims priority to, and the benefit of, U.S. Prov. App. Ser. No. 62/126,231, filed Feb. 27, 2015, entitled “Payment Checkout Within an Application,” the entire content of which is incorporated herein by reference.

### BACKGROUND

Consumers have been slow to adopt mobile payment applications for a variety of reasons, from a lack of understanding to a lack of time. Mobile applications can make it easier for people to pay for goods and services. In addition, mobile applications can work inside the applications of other merchants to further enhance merchant applications.

### SUMMARY

The following presents a simplified summary of the present disclosure in order to provide a basic understanding of some aspects of the disclosure. This summary is not an extensive overview. It is not intended to identify key or critical elements of the disclosure or to delineate its scope. The following summary merely presents some concepts in a simplified form as a prelude to the more detailed description provided below.

In one aspect, a computer system is disclosed which assists a user in making a transaction by using a call identifier (“Call ID”). A payment processor server may receive from a consumer portable computing device a total amount due previously received from a point of sale (POS) terminal along with the consumer's payment credential. The payment processor server may respond to the consumer portable computing device with a Call ID. The payment processor server may then receive from the POS the Call ID transmitted from consumer portable computing device and the total amount due from a merchant backend computing system. The payment processor server may verify the CALL ID from the POS and transaction amount from the merchant backend system and purchase data with a merchant processor/acquirer; and in response to the payment processor server verifying the CALL ID from the POS and transaction amount from the merchant backend system and purchase data with the merchant processor/acquirer, the payment processor server may inform the POS through the merchant backend computing system that the transaction is authorized.

In accordance with example embodiments, a system, method, apparatus, and computer readable medium are disclosed. In an example, the example embodiments may provide for receiving from a portable computing device a first payment authorization request message comprising a total amount due and a payment credential, wherein the total amount due is associated with a point of sale terminal, and responding to the portable computing device with a first call identifier. The example embodiments may further provide for receiving a second payment authorization request comprising a second call identifier from a merchant backend server, comparing the first call identifier and the second call identifier for verification, and, in response to a successful comparison, communicating a message indicating that the first call identifier has been verified.

### BRIEF DESCRIPTION OF THE DRAWINGS

The invention may be better understood by references to the detailed description when considered in connection with the accompanying drawings. The components in the figures are not necessarily to scale, emphasis instead being placed upon illustrating the principles of the invention. In the figures, like reference numerals designate corresponding parts throughout the different views.

FIG. 1 may be an example embodiment of one method;

FIG. 2 may be example communication flow between various devices;

FIG. 3 may be an illustration of a computer system;

FIG. 4 may be an illustration of a portable computing device; and

FIG. 5 may be an illustration of a server computing device.

Persons of ordinary skill in the art will appreciate that elements in the figures are illustrated for simplicity and clarity so not all connections and options have been shown to avoid obscuring the inventive aspects. For example, common but well-understood elements that are useful or necessary in a commercially feasible embodiment are not often depicted in order to facilitate a less obstructed view of these various embodiments of the present disclosure. It will be further appreciated that certain actions and/or steps may be described or depicted in a particular order of occurrence while those skilled in the art will understand that such specificity with respect to sequence is not actually required. It will also be understood that the terms and expressions used herein are to be defined with respect to their corresponding respective areas of inquiry and study except where specific meanings have otherwise been set forth herein.

### SPECIFICATION

The present invention now will be described more fully with reference to the accompanying drawings, which form a part hereof, and which show, by way of illustration, specific exemplary embodiments by which the invention may be practiced. These illustrations and exemplary embodiments are presented with the understanding that the present disclosure is an exemplification of the principles of one or more inventions and is not intended to limit any one of the inventions to the embodiments illustrated. The invention may be embodied in many different forms and should not be construed as limited to the embodiments set forth herein; rather, these embodiments are provided so that this disclosure will be thorough and complete, and will fully convey the scope of the invention to those skilled in the art. Among other things, the present invention may be embodied as methods, systems, computer readable media, apparatuses, or devices. Accordingly, the present invention may take the form of an entirely hardware embodiment, an entirely software embodiment, or an embodiment combining software and hardware aspects. The following detailed description is, therefore, not to be taken in a limiting sense.

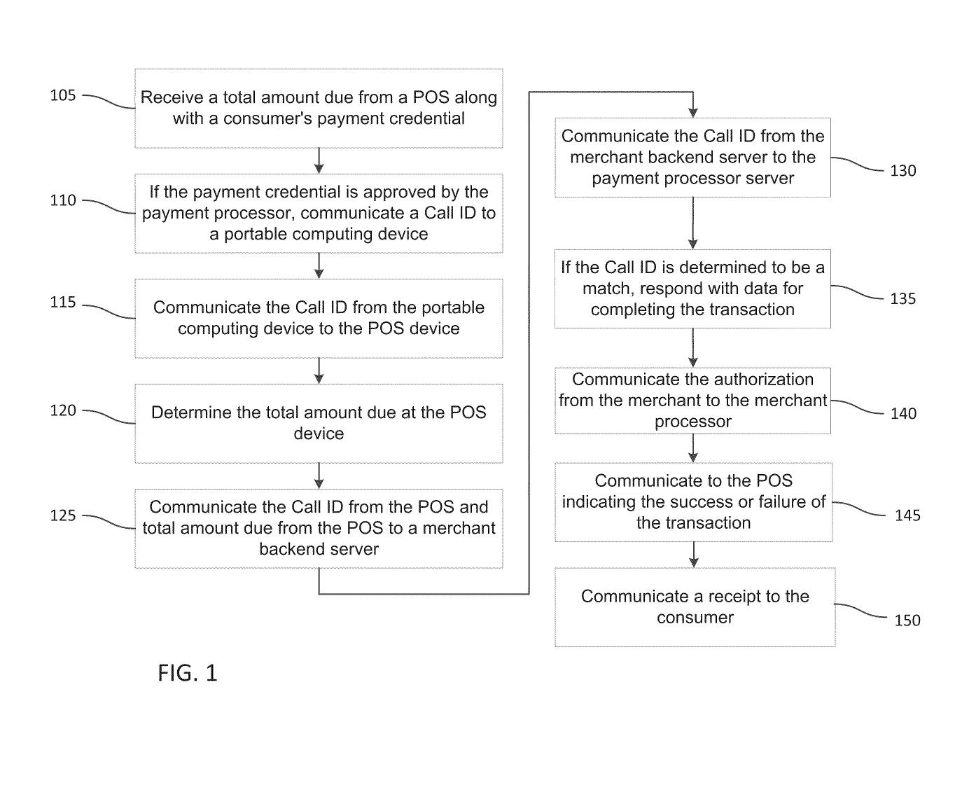

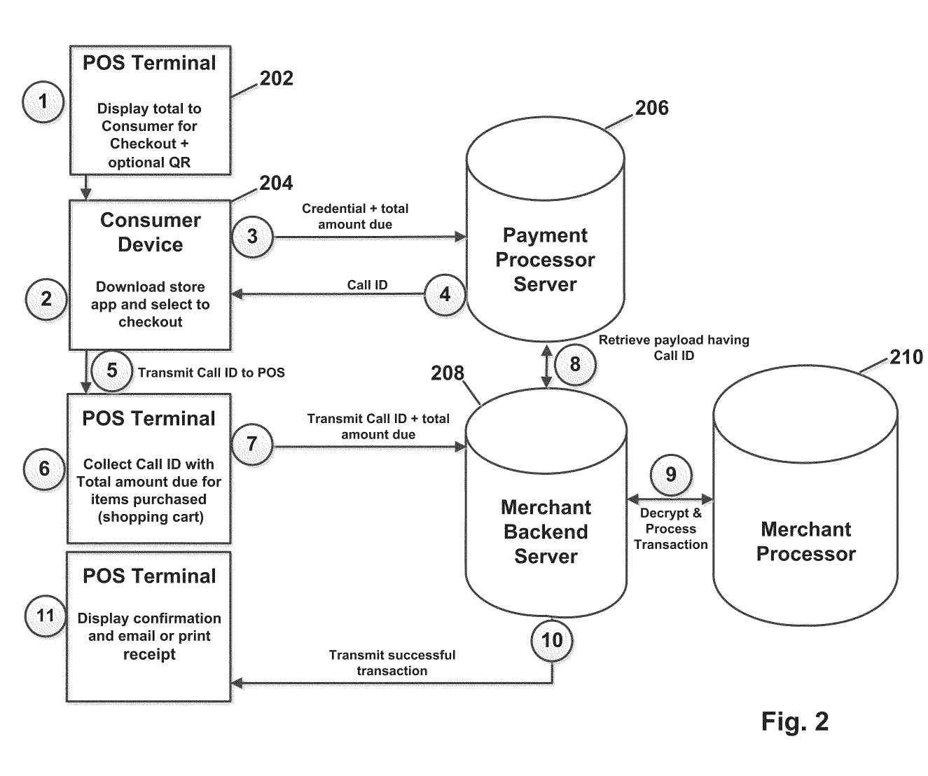

As illustrated in FIGS. 1 and 2, at a high level, a consumer making a purchase at a retailer may receive a total amount due at a consumer device 204 from a point of sale terminal 202 (the POS), and pass that amount along with the consumer's payment credential to a payment processor server 206. The devices, terminals, computers, servers, etc., described herein may have at least one processor which may be physically configured according to computer executable instructions stored by at least one memory or other non-transitory computer readable medium. The computer executable instructions may be understood as blocks of code. FIG. 1 may illustrate the blocks of code that physically configure the processor.

The payment processor server 206 may respond to the consumer with a “Call ID”, which the consumer device 204 may transmit in a variety of ways to the POS terminal 202. In some examples, the payment processer server 206 may be implemented as a cloud based system. In an example, the Call ID may be a unique code generated for use with a single or multiple transactions. For example, the payment processor server 206 may generate the Call ID using a number generator (e.g., a pseudo random number generator) seeded with one or more values. Example seeds include a current time and/or date, a hash of a device identifier of device 204 and the current time, and the like.

Referring to FIG. 1, computer executable blocks in a computer system for approving transactions may be graphically displayed. At block 105, a payment processor server 206 may be programmed for receiving from a consumer portable computing device 204 a total amount due to a POS 202 along with the consumer's payment credential. In some embodiments, the POS may communicate the amount due to the payment processor server 206 through a POS communication system. In another embodiment, the amount due is combined with the payment credential which may be communicated through the POS communication system. In a further embodiment, the amount due is communicated in a first format and the payment credential may be communicated in a second format and the amount due and payment credential may be communicated using the same or different communication manners.

Point of sale devices may take on a variety of forms and complexity. Depending on the form factors used in the various embodiments, the POS 202 may have a variety of capabilities. In some embodiments, communication to and from the POS 202 may be wireless and may occur according to a variety of protocols such as Bluetooth, 802.11, infrared, 60 MHz, and other appropriate wireless protocols. Thus, the POS terminal 202 may have the appropriate wireless capability as part of the POS terminal 202.

In yet another embodiment, a secondary receiver which is not part of the POS device 202 may be used for wireless communication. The wireless receiver may be in communication with a backend server which may accept and match up the data from the POS terminal 202 and the wireless receiver such that the appropriate wireless data is matched with the appropriate POS data. For example, a Bluetooth receiver may be located in a ceiling near a POS device 202 and the Bluetooth receiver may communicate with a back end system, a computing system that is part of a computing cloud or with the POS device itself.

In a further embodiment, the portable consumer device 204 may have communication capability which may be leveraged in a variety of ways. For example, the portable consumer device 204 may communicate a payment credential using cellular technology to a cloud computing facility which may match up payment data with the payment credential. Of course, other manners of receiving the payment data and the payment credential and communicating the payment data and the payment credential are possible and are contemplated.

The payment credential may include an account identifier and a password. The account identifier may be an account number or an account identifier that has previously been set up as an indicator or the account number. In some embodiments, tokens may be provisioned and used as part of the payment credential.

In some embodiments, the payment credential may be entered in a payment application executing on the portable consumer device 204. The payment application may be preloaded and may facilitate electronic transactions, such as by accepting an id and personal identification number (PIN) and configuring tokens to be used to complete the transaction.

In yet another embodiment, the payment application may execute inside an additional application. For example, a vendor may have an application which displays goods and an additional application may be called to pay for the good. As an example, a user may shop for jeans and once the desired jeans are in a checkout cart, a payment application may be called which may enable payments in a secure manner. The payment application, such as Visa Checkout®, may be secure, easy to use and may relieve the store of the burden of creating a payment application. In addition, the payment application may make it easy for a consumer to receive receipts, track expenses, and track a budget. Further, the user may select from a plurality of payment credentials from a single payment application. As an example, a user may select to use a mileage based Visa® account to buy jeans and may use a cash reward Visa® account to make a down payment on a car.

Referring again to FIG. 1, at block 110, if the payment credential is approved by the payment processer server 206, the server 204 may communicate a Call ID to the portable consumer device 204. In an example, the payment processer server 206 may confirm that the payment credential is associated with a valid account that is in good standing, and that the consumer has adequate funds for the amount due. The Call ID may be created by an authority such as by a payment account issuer operating the payment processor server 206. The Call ID may take on a variety of forms. In some embodiments, the Call ID may be a random set of bytes. In other embodiments, the Call ID may be a QR code and/or a bar code that may be displayed on the portable computing device. Logically, the Call ID may be communicated in an encrypted format or in other manners to improve security. For example, the Call ID may be communicated as a QR code or a bar code while in other embodiment, the Call ID may be a series of bytes that are transformed into a QR code or a bar code using an algorithm in the payment application.

For even more security, the Call ID may be communicated in an additional communication band. For example, if the payment credential and payment amount are communicated by a payment network, the Call ID may be communicated through a cellular network. In addition, the Call ID may be communicated as part of an SMS message, an email, a text message or through any other appropriate band.

In an example with reference to FIG. 2, a consumer may desire to purchase one or more items (e.g., product and/or service) from a merchant and may approach a POS 202. The items being purchased may be scanned and the POS 202 may display a total to the consumer optionally along with a QR code. The consumer may download a store app (or launch the store app if previously downloaded) and scan the QR code. The consumer may be given the option to approve payment. If approved, the portable consumer device 204 may communicate a payment credential to a payment processor server 206. For example, the consumer device 204 may communicate a payment authorization request message that includes a total amount due received from the POS 202 and a payment credential of the consumer. The payment processor server 206 may authenticate the consumer and validate the payment credential. For example, the payment credential may include an account identifier and a password associated with an account the consumer previously established. If successfully authenticated and validated, the payment processor server 206 may communicate a Call ID to the portable consumer device 204. If unsuccessful, the payment processor server 206 may inform the POS 202 and/or the consumer device 204 of the failure to authenticate and/or validate.

At block 115, the Call ID may be communicated from the portable consumer device 204 to the POS 202. For example, the POS 202 may transmit the Call ID and the total amount due to the merchant's backend server 208, which may validate the Call ID with the payment processor server 206. The Call ID may be communicated to the POS 202 in a variety of ways. If the Call ID is a series of digits, the digits may be manually entered into the POS 202. If other embodiments, the variety of communication forms may be used to communicate the Call ID via an additional communication band. Logically, if the POS 202 and portable consumer device 204 support wireless communication, the Call ID may be communicated from the portable consumer device 204 to the POS 202 using wireless protocols. If the POS 202 does not support wireless communication, a separate wireless receiver may be used to communicate the Call ID to the merchant server 208. Of course, the Call ID may be communicated in a variety of appropriate manners which are possible and contemplated. For example, the portable consumer device 204 may communicate the Call ID to the POS 202.

At block 120, the total amount due may be determined at the POS device 202. Logically, the POS device 202 may have access to the total due from a cash register or from the merchant server 208 such as in some embodiments where the total amount due is processed at the point of payment and then communicated to the merchant server 208. The total amount due may be used to determine the amount to debit and may be used as an additional check on the authentication of the transaction.

At block 125, the CALL ID received from the payment processor server 206 and transaction amount from the POS 202 may be communicated to a merchant backend server 208 which may be a cloud based system. In short, the received data may be checked to ensure the transaction is not fraudulent. By checking that the amount from the POS 202 matches the amount from the merchant backend system, fraud may be less likely. The communication may be through the payment network or another network. Further, the communication may be subject to security steps such as encryption and hashing. The Call ID is may be encrypted and may be decrypted by the payment processor server 206. For example, the POS 202 may receive the Call ID from the portable consumer device 204. Subsequent to receipt, the POS 202 may communicate the Call ID and the total amount due to a merchant server 208 (or other computerized backend system for collecting payment (e.g., cloud-based)). The match may be determined in a variety of ways such as comparing images or bytes or bits of the two Call IDs.

At block 130, the merchant server 208 may communicate the received Call ID to the payment processor server 206. The communication may be through the payment network or another network. Further, the communication may be subject to security steps such as encryption and hashing. In an example, the merchant backend server 208 may communicate a second payment authorization request comprising a second call identifier. The payment processor server 206 may then confirm that the second Call ID is the same Call ID that it previously communicated to the consumer device 204. The payment processor server 206 may send to the merchant backend server 208 a message confirming or denying a match between the Call IDs (e.g., indicating whether the Call ID can be verified). If there is a match, the message may also indicate that the payment transaction is authorized.

At block 135, if the Call ID is determined to be a match, the merchant backend server 208 may respond to the POS 202 with a data payload for completing the transaction such as an authorization to the merchant.

At block 140, in some embodiments, the authorization may then be communicated from the merchant backend server 208 to a merchant processor 210 which may decrypt the communication and return with an indication to the merchant backend server 208 that the transaction was or was not successful. The communication may be through the payment network or another network. Further, the communication may be subject to security steps such as encryption and hashing. For example, upon verification by the payment processor server 206, the merchant server 208 may communicate with a merchant processor/acquirer 210 to determine whether the transaction was or was not successful. If the transaction is performed successfully, the merchant backend server 208 may notify the POS 202 that the transaction was successful. Conversely, if unsuccessful, the merchant processor/acquirer 210 may inform the merchant backend server 208 which may notify the POS 202 that the transaction was unsuccessful.

At block 145, a communication may be sent to the POS 202 indicating success or failure of the transaction. The communication may be through the payment network or another network. Further, the communication may be subject to security steps such as encryption and hashing. The communication may be as simple as an authorization indication or may be more complicated such as an authorization code, a standing in a frequent buyer program, an indication of a future sale, a coupon, an advertisement for a product, etc.

At block 150, a receipt may be communicated to the consumer. The receipt may be communicated in a variety of ways In some ways, the receipt may be communicated to the POS 202 that causes generation of a paper receipt. In other embodiments, the receipt may be wirelessly communicated to the portable consumer device 204. The portable consumer device 204 may electronically display the receipt in a payment app or the receipt may be stored in a receipt folder on the portable consumer device 204. In other embodiments, the receipt may be communicated to the consumer device 204 as a text, as an email or as another electronic communication.

As a result, payments may be made at a retail POS 202 via a consumer device 204 (e.g., a user's smartphone) without requiring a specific contactless protocol and without needing an actual card or personal account number (PAN), as the transaction uses the consumer device 204 to access a payment application (e.g., Visa Checkout®). The consumer device 204 may communicate transaction details and credentials to the payment application, and the merchant may then verify those transaction details through communications between the merchant's backend server 208 and the payment processor server 206.

The example embodiments may beneficially provide technical solutions to one or more technical challenges. Existing payment processing networks and electronic messaging schemes fail to adequately protect purchase transactions being conducted electronically. The example embodiments provide for a payment processor to communicate a call identifier to multiple different devices and to determine whether that same call identifier is received back from the different parties prior to authorizing a transaction.

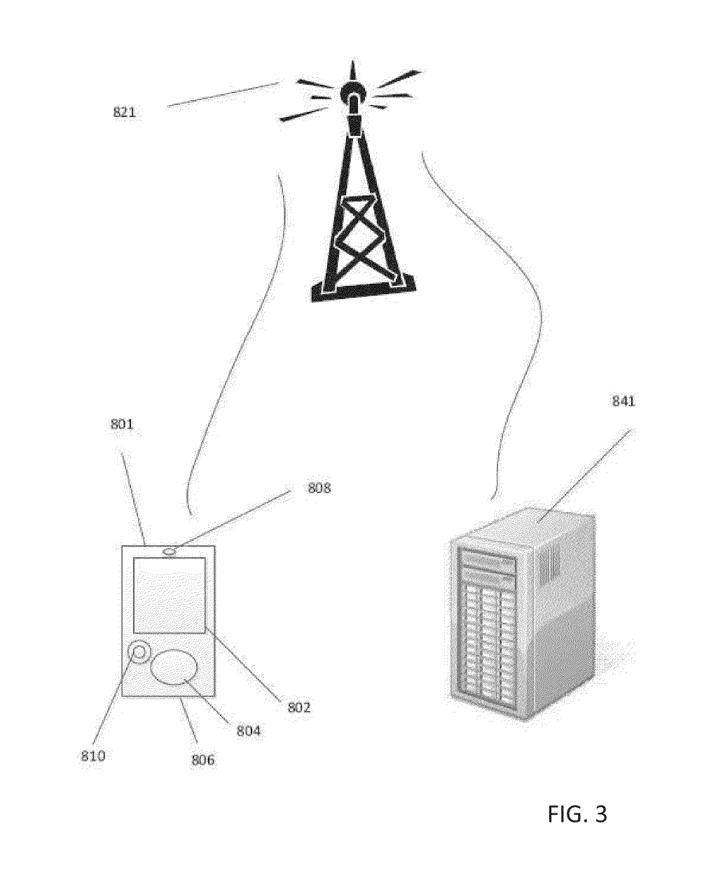

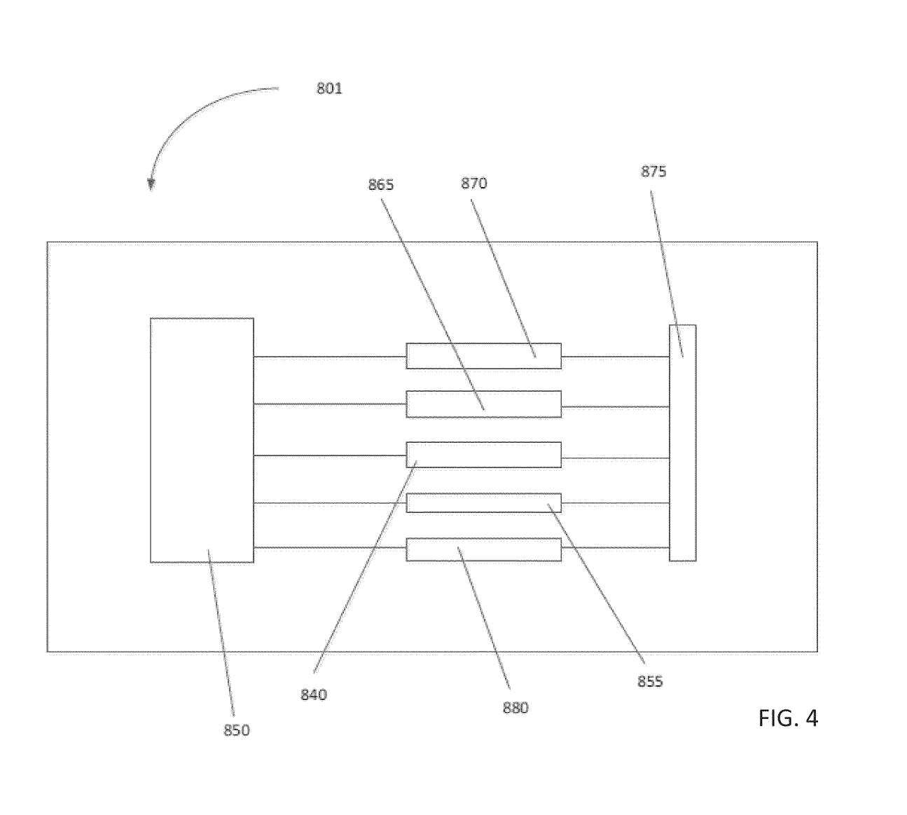

FIG. 3 may be a high level illustration of some of the elements a sample computing system that may be physically configured to implement the method and system. The computing system may be a dedicated computing device 841, a dedicated portable computing device 801, an application on the computing device 841, an application on the portable computing device 801 or a combination of all of these. FIG. 4 may be a high level illustration of a portable computing device 801 communicating with a remote computing device 841 but the application may be stored and accessed in a variety of ways. In addition, the application may be obtained in a variety of ways such as from an app store, from a web site, from a store Wi-Fi system, etc. There may be various versions of the application to take advantage of the benefits of different computing devices, different languages and different API platforms.

In one embodiment, a portable computing device 801 may be a device that operates using a portable power source 855 such as a battery. The portable computing device 801 may also have a display 802 which may or may not be a touch sensitive display. More specifically, the display 802 may have a capacitance sensor, for example, that may be used to provide input data to the portable computing device 801. In other embodiments, an input pad 804 such as arrows, scroll wheels, keyboards, etc., may be used to provide inputs to the portable computing device 801. In addition, the portable computing device 801 may have a microphone 806 which may accept and store verbal data, a camera 808 to accept images and a speaker 810 to communicate sounds.

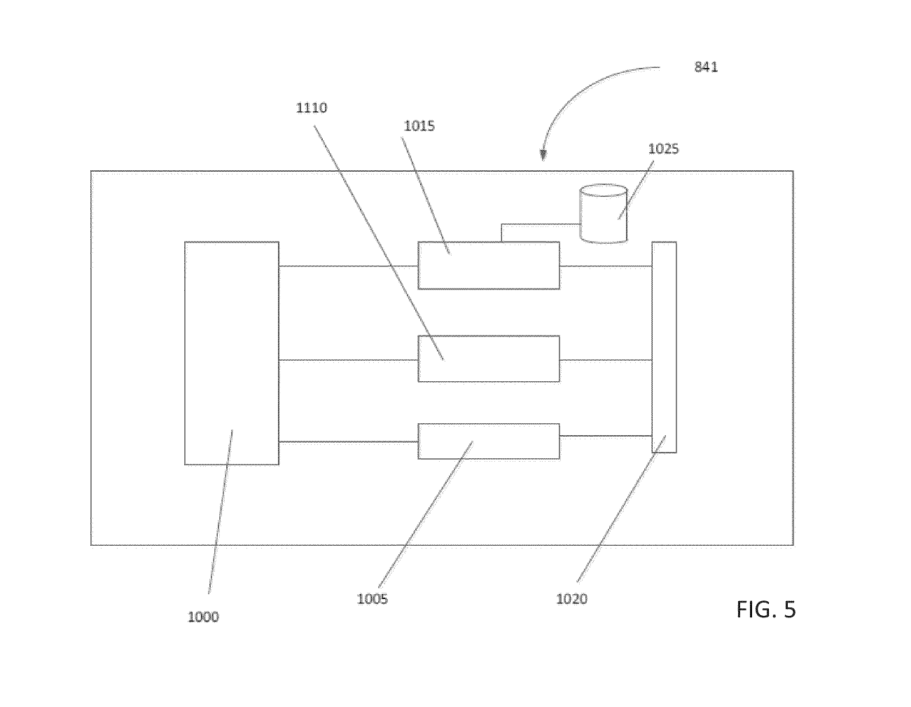

The portable computing device 801 may be able to communicate with a computing device 841 or a plurality of computing devices 841 that make up a cloud of computing devices 811. The portable computing device 801 may be able to communicate in a variety of ways. In some embodiments, the communication may be wired such as through an Ethernet cable, a USB cable or RJ6 cable. In other embodiments, the communication may be wireless such as through Wi-Fi (802.11 standard), Bluetooth, cellular communication or near field communication devices. The communication may be direct to the computing device 841 or may be through a communication network 102 such as cellular service, through the Internet, through a private network, through Bluetooth, etc. FIG. 4 may be a simplified illustration of the physical elements that make up a portable computing device 801 and FIG. 5 may be a simplified illustration of the physical elements that make up a server type computing device 841.

FIG. 4 may be a sample portable computing device 801 that is physically configured according to be part of the system. The portable computing device 801 may have a processor 850 that is physically configured according to computer executable instructions. It may have a portable power supply 855 such as a battery which may be rechargeable. It may also have a sound and video module 860 which assists in displaying video and sound and may turn off when not in use to conserve power and battery life. The portable computing device 801 may also have volatile memory 865 and non-volatile memory 870. It may have GPS capabilities 880 that may be a separate circuit or may be part of the processor 850. There also may be an input/output bus 875 that shuttles data to and from the various user input devices such as the microphone 806, the camera 808 and other inputs 802, etc. It also may control of communicating with the networks, either through wireless or wired devices. Of course, this is just one embodiment of the portable computing device 801 and the number and types of portable computing devices 801 is limited only by the imagination.

As a result of the system, better information may be provided to a user at a point of sale. The information may be user specific and may be required to be over a threshold of relevance. As a result, users may make better informed decisions. The system is more than just speeding a process but uses a computing system to achieve a better outcome.

The physical elements that make up the remote computing device 841 may be further illustrated in FIG. 5. At a high level, the computing device 841 may include a digital storage such as a magnetic disk, an optical disk, flash storage, non-volatile storage, etc. Structured data may be stored in the digital storage such as in a database. The server 841 may have a processor 1000 that is physically configured according to computer executable instructions. It may also have a sound and video module 1005 which assists in displaying video and sound and may turn off when not in use to conserve power and battery life. The server 841 may also have volatile memory 1010 and non-volatile memory 1015.

The database 1025 may be stored in the memory 1010 or 1015 or may be separate. The database 1025 may also be part of a cloud of computing device 841 and may be stored in a distributed manner across a plurality of computing devices 841. There also may be an input/output bus 1020 that shuttles data to and from the various user input devices such as the microphone 806, the camera 808, the inputs 802, etc. The input/output bus 1020 also may control of communicating with the networks, either through wireless or wired devices. In some embodiments, the application may be on the local computing device 801 and in other embodiments, the application may be remote 841. Of course, this is just one embodiment of the server 841 and the number and types of portable computing devices 841 is limited only by the imagination.

The user devices, computers and servers described herein may be general purpose computers that may have, among other elements, a microprocessor (such as from the Intel Corporation, AMD or Motorola); volatile and non-volatile memory; one or more mass storage devices (i.e., a hard drive); various user input devices, such as a mouse, a keyboard, or a microphone; and a video display system. The user devices, computers and servers described herein may be running on any one of many operating systems including, but not limited to WINDOWS, UNIX, LINUX, MAC OS, or Windows (XP, VISTA, etc.). It is contemplated, however, that any suitable operating system may be used for the present invention. The servers may be a cluster of web servers, which may each be LINUX based and supported by a load balancer that decides which of the cluster of web servers should process a request based upon the current request-load of the available server(s).

The user devices, computers and servers described herein may communicate via networks, including the Internet, WAN, LAN, Wi-Fi, other computer networks (now known or invented in the future), and/or any combination of the foregoing. It should be understood by those of ordinary skill in the art having the present specification, drawings, and claims before them that networks may connect the various components over any combination of wired and wireless conduits, including copper, fiber optic, microwaves, and other forms of radio frequency, electrical and/or optical communication techniques. It should also be understood that any network may be connected to any other network in a different manner. The interconnections between computers and servers in system are examples. Any device described herein may communicate with any other device via one or more networks.

The example embodiments may include additional devices and networks beyond those shown. Further, the functionality described as being performed by one device may be distributed and performed by two or more devices. Multiple devices may also be combined into a single device, which may perform the functionality of the combined devices.

The various participants and elements described herein may operate one or more computer apparatuses to facilitate the functions described herein. Any of the elements in the above-described Figures, including any servers, user devices, or databases, may use any suitable number of subsystems to facilitate the functions described herein.

Any of the software components or functions described in this application, may be implemented as software code or computer readable instructions that may be executed by at least one processor using any suitable computer language such as, for example, Java, C++, or Perl using, for example, conventional or object-oriented techniques.

The software code may be stored as a series of instructions or commands on a non-transitory computer readable medium, such as a random access memory (RAM), a read only memory (ROM), a magnetic medium such as a hard-drive or a floppy disk, or an optical medium such as a CD-ROM. Any such computer readable medium may reside on or within a single computational apparatus and may be present on or within different computational apparatuses within a system or network.

It may be understood that the present invention as described above can be implemented in the form of control logic using computer software in a modular or integrated manner. Based on the disclosure and teachings provided herein, a person of ordinary skill in the art may know and appreciate other ways and/or methods to implement the present invention using hardware, software, or a combination of hardware and software.

The above description is illustrative and is not restrictive. Many variations of the invention will become apparent to those skilled in the art upon review of the disclosure. The scope of the invention should, therefore, be determined not with reference to the above description, but instead should be determined with reference to the pending claims along with their full scope or equivalents.

One or more features from any embodiment may be combined with one or more features of any other embodiment without departing from the scope of the invention. A recitation of “a”, “an” or “the” is intended to mean “one or more” unless specifically indicated to the contrary. Recitation of “and/or” is intended to represent the most inclusive sense of the term unless specifically indicated to the contrary.

One or more of the elements of the present system may be claimed as means for accomplishing a particular function. Where such means-plus-function elements are used to describe certain elements of a claimed system it will be understood by those of ordinary skill in the art having the present specification, figures and claims before them, that the corresponding structure is a general purpose computer, processor, or microprocessor (as the case may be) programmed to perform the particularly recited function using functionality found in any general purpose computer without special programming and/or by implementing one or more algorithms to achieve the recited functionality. As would be understood by those of ordinary skill in the art that algorithm may be expressed within this disclosure as a mathematical formula, a flow chart, a narrative, and/or in any other manner that provides sufficient structure for those of ordinary skill in the art to implement the recited process and its equivalents.

While the present disclosure may be embodied in many different forms, the drawings and discussion are presented with the understanding that the present disclosure is an exemplification of the principles of one or more inventions and is not intended to limit any one of the inventions to the embodiments illustrated. The attached Appendix may provide more detail regarding the operation of a payment system.

The present disclosure provides a solution to the long-felt need described above. In particular, the systems and methods described herein may be configured for improving payment systems. Further advantages and modifications of the above described system and method will readily occur to those skilled in the art. The disclosure, in its broader aspects, is therefore not limited to the specific details, representative system and methods, and illustrative examples shown and described above. Various modifications and variations can be made to the above specification without departing from the scope or spirit of the present disclosure, and it is intended that the present disclosure covers all such modifications and variations provided they come within the scope of the following claims and their equivalents.

1. A computer system comprising:
at least one processor; and
at least one non-transitory computer readable medium storing computer executable instructions that, when executed, cause the computer system at least to perform:
receiving from a portable computing device a first payment authorization request message comprising a total amount due and a payment credential, wherein the total amount due is associated with a point of sale terminal;
responding to the portable computing device with a first call identifier;
receiving a second payment authorization request comprising a second call identifier from a merchant backend server;
comparing the first call identifier and the second call identifier for verification; and
in response to a successful comparison, communicating a message indicating that the first call identifier has been verified.

2. The computer system of claim 1, wherein the total amount due is received by the portable computing device from the point of sale terminal.

3. The computer system of claim 2, wherein the total amount due is received via a wireless communication protocol.

4. The computer system of claim 1, wherein the payment credential comprises an account identifier and a password.

5. The computer system of claim 1, wherein the first call identifier is at least one of a QR code or a bar code.

6. The computer system of claim 1, wherein a payment receipt is communicated to the portable computing device.

7. The computer system of claim 1, wherein the computer executable instructions, when executed, further cause the computer system at least to perform encrypting the first call identifier prior to sending to the portable computing device.

8. A non-transitory computer readable medium storing computer executable instructions that, when executed, cause a computer system at least to perform:
receiving from a portable computing device a first payment authorization request message comprising a total amount due and a payment credential, wherein the total amount due is associated with a point of sale terminal;
responding to the portable computing device with a first call identifier;
receiving a second payment authorization request comprising a second call identifier from a merchant backend server;
comparing the first call identifier and the second call identifier for verification; and
in response to a successful comparison, communicating a message indicating that the first call identifier has been verified.

9. The computer readable medium of claim 8, wherein the total amount due is received by the portable computing device from the point of sale terminal.

10. The computer readable medium of claim 9, wherein the total amount due is received via a wireless communication protocol.

11. The computer readable medium of claim 8, wherein the payment credential comprises an account identifier and a password.

12. The computer readable medium of claim 8, wherein the first call identifier is at least one of a QR code or a bar code.

13. The computer readable medium of claim 8, wherein a payment receipt is communicated to the portable computing device.

14. The computer readable medium of claim 8, wherein the computer executable instructions that, when executed, further cause the computer system at least to perform encrypting the first call identifier prior to sending to the portable computing device.

15. A computer-implemented method comprising:
receiving, by a payment processor server from a portable computing device, a first payment authorization request message comprising a total amount due and a payment credential, wherein the total amount due is associated with a point of sale terminal;
responding to the portable computing device with a first call identifier by the payment processor server;
receiving a second payment authorization request comprising a second call identifier from a merchant backend server;
comparing, by the payment processor server, the first call identifier and the second call identifier for verification; and
in response to a successful comparison, communicating a message indicating that the first call identifier has been verified.

16. The method of claim 15, wherein the total amount due is received by the portable computing device from the point of sale terminal.

17. The method of claim 16, wherein the total amount due is received via a wireless communication protocol.

18. The method of claim 15, wherein the payment credential comprises an account identifier and a password.

19. The method of claim 15, wherein the first call identifier is at least one of a QR code or a bar code.

20. The method of claim 15, wherein the computer executable instructions that, when executed, further cause the computer system at least to perform encrypting the first call identifier prior to sending to the portable computing device.
